(19) United States
(12) Patent Application Publication
(10) Pub. No.: US 2024/0086970 A1
(43) Pub. Date: Mar. 14, 2024

(54) TECHNIQUES FOR ESTABLISHING AND APPLYING CUSTOM, AUTOMATIC EXIT CRITERIA FOR AN AUTOMATED MARKETING CAMPAIGN

(71) Applicant: Twilio Inc., San Francisco, CA (US)

(72) Inventors: Nathanael Thompson, San Francisco, CA (US); David Zuluaga, San Francisco, CA (US); Andrew Hoyle, San Francisco, CA (US)

(21) Appl. No.: 18/087,489

(22) Filed: Dec. 22, 2022

Related U.S. Application Data
(60) Provisional application No. 63/406,149, filed on Sep. 13, 2022.

(51) Int. Cl. G06Q 30/0251

(52) U.S. Cl. CPC G06Q 30/0269; G06Q 30/0255

(57) ABSTRACT

Described herein are techniques for conducting an automated marketing campaign, having predefined exit criteria for removing a contact from the target audience of the automated marketing campaign, subsequent to initiating the automated marketing campaign. The exit criteria are specified as one or more conditional statements, which reference values in the contact record of the contact. Accordingly, as a contact record is updated by a contacts service over the course of the automated marketing campaign, data written to the contact record may cause the contact to be removed from the target audience.

### RELATED APPLICATIONS

This application claims the benefit of U.S. Provisional Patent Application No. 63/406,149, filed Sep. 13, 2022, which is incorporated by reference herein in its entirety.

### TECHNICAL FIELD

The present application generally relates to messaging systems that provide for the creation and execution of automated marketing campaigns. More precisely, the present application describes an innovative technique providing a marketer with a means for establishing customized exit criteria for an automated marketing campaign, where each instance of a customized exit criterion specifies one or more conditions, which, when satisfied, will cause a contact (e.g., a targeted message recipient) for the automated marketing campaign to be removed from the target audience for the automated marketing campaign.

### BACKGROUND

In marketing, messaging systems (e.g., email, SMS, text message, instant messages, etc.) are frequently utilized by marketers as one of a variety of tools for executing a marketing campaign. A messaging system is a software-based system that allows a marketer or marketing team to author one or more messages, and then, in some instances, automate the delivery of the messages to each member of a target audience. Often, the one or more messages share a common theme or objective. For example, an automated marketing campaign may be established to welcome new end-users to a web-based service after each end-user initially registers as an end-user of the service. As such, each message may provide information that introduces the new end-user to a different aspect or feature of the web-based service, with the ultimate objective of encouraging new end-user engagement with the service. In yet another example, a promotional marketing campaign may be established to promote a new feature or service. An automated marketing campaign may be established to encourage an end-user to connect with an enterprise via one or more social networking channels. An automated marketing campaign—sometimes referred to as a “post purchase” campaign—may be established to send messages to customers who have recently made a purchase. Accordingly, one message in the automated marketing campaign may promote products that are complementary to the one previously purchased. Another message in the marketing campaign may encourage the customer to provide a web-based review of the product or service that was purchased. Of course, many other types of automated marketing campaigns are possible.

### BRIEF DESCRIPTION OF THE DRAWINGS

Embodiments of the present invention are illustrated by way of example and not limitation in the figures of the accompanying drawings, in which:

FIG. 1 is a diagram illustrating an example of a customer data platform with which a messaging system, having an automated marketing campaign feature, consistent with embodiments of the present invention, may be integrated and deployed.

FIG. 2 is a diagram illustrating an example of a contacts database including contacts that may be included as members of a target audience for an automated marketing campaign, consistent with embodiments of the invention.

FIG. 3 is a user interface diagram illustrating an example of a user interface via which an end-user may specify a target audience for an automated marketing campaign by defining a segment, consistent with embodiments of the present invention.

FIG. 4 is a user interface diagram illustrating an example of a user interface via which an end-user may establish various configuration parameters for executing an automated marketing campaign, consistent with some embodiments of the present invention.

FIG. 5 is a user interface diagram illustrating an example of a user interface via which an end-user may specify whether an automated marketing campaign is to include custom exit criteria, and if so, a condition, which, when satisfied, will cause a contact to be removed from the target audience for the marketing campaign, according to some embodiments.

FIG. 6 is a diagram illustrating an example of various functional components included in a messaging system that facilitates automated marketing campaigns that support automated exit criteria, consistent with embodiments of the invention.

FIG. 7 is an example of a computer system with which any of the methodologies described herein may be implemented.

FIG. 8 is a diagram illustrating an example of a software architecture or framework, which may be used in implementing any of the various systems and methodologies described herein.

### DETAILED DESCRIPTION

Described herein are methods and systems that provide for the creation and execution of automated marketing campaigns that support customized exit criteria—specifically, the creation of rules-based conditions or conditional statements, which, when satisfied, will cause a contact who is a member of the target audience for a marketing campaign to be removed from the target audience of that marketing campaign, thereby ensuring that the contact does not receive additional messages. In addition to improving the end-user experience by eliminating the sending of irrelevant messages to contacts, the data analytics and reporting for marketing campaigns is improved by generating data to indicate what caused a contact to exit a marketing campaign. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

For purposes of the present disclosure, the terms “automated marketing campaign,” “marketing campaign automation,” and simply, “automation” are used synonymously in reference to a pre-defined series of messages that are scheduled for communication to a message recipient who is a member of a target audience. For instance, each automation or automated marketing campaign is defined by a set of configuration parameters and associated content (e.g., messages), where the configuration parameters define the target audience, the schedule by which messages are communicated to members of the target audience, the entry and exit criteria for the target audience, and other aspects that determine the behavior for the automation. The terms “end-user” and “marketer” are used synonymously in reference to a person who uses a software-based messaging system to establish and conduct an automated marketing campaign. Similarly, the terms “contact” and “customer” are used in reference to a person who may be specified as a message recipient, as part of a target audience for an automated marketing campaign, and as a result, receive messages as part of an automated marketing campaign. While the terms “customer” and “contact” may both be used to reference a person to whom a message may be communicated, at least in some instances, a customer profile, stored in a customer profile database, may be created separately, distinct from a contact record, stored in a contacts database. For instance, at least with some embodiments, a customer profile may exist for a customer whose identity is not known. However, in general, a contact record exists in a contacts database for only those customers whose identity has been resolved and for which some identifying information is known (e.g., an email address or telephone number). As described in detail below, the messaging system leverages the contact records stored in a contacts database for purposes of defining the target audience for an automated marketing campaign. For example, a marketer, as an end-user of a messaging application or system, may interact with various user interfaces of the messaging system to author or create messages (e.g., emails, SMS or text messages, instant messages) and establish configuration parameters for an automated marketing campaign. Once the automated marketing campaign is activated or invoked, contacts, who are defined to be part of the target audience, will receive messages while the contacts remain part of the target audience. However, before sending a message to a contact, the messaging system will verify that a contact record associated with the contact has not been updated in some way that would cause the contact to be removed from the target audience.

An automated marketing campaign may involve a set of messages that are automatically communicated to a contact that is specified as a member of a target audience for the marketing campaign. For example, for a specific automated marketing campaign, a marketer will generally create a series or sequence of messages that are to be communicated to a contact, one message at a time and in an order established by the marketer. Generally, the messaging system will ensure that some duration of time has passed between the sending of messages to the same contact. The specific duration of time may be established as a system default, or in some instances may be customized by the end-user on a per message basis. Each message is typically created for the purpose of influencing or persuading the behavior of the message recipient, for example, by encouraging the message recipient to take some specific action. Accordingly, a marketer may have many different automated marketing campaigns, with each individual marketing campaign being associated with a different objective or goal.

With conventional messaging systems, once an automated marketing campaign has been initiated for a particular target audience, the marketing campaign executes until each contact has received all messages that are defined by the marketer to be part of the automated marketing campaign. Accordingly, with conventional messaging systems, there is no mechanism by which a marketer can plan—for example, at the time of establishing the automated marketing campaign—to have a contact removed from the target audience defined for the automated marketing campaign. Conventional messaging systems that provide for the creation and execution of automated marketing campaigns generally do not allow for the automated removal of a contact from the target audience. For instance, with conventional marketing campaigns, once a contact becomes a member of the target audience for a marketing campaign, the contact remains a member of the target audience until he or she has been sent each and every message that is part of the marketing campaign. Accordingly, only after the contact has received all messages that are part of the automated marketing campaign is the contact removed from the target audience.

In some instances, a message may include instructions on how to reply so that a contact may be provided with a means to take some explicit action to remove him or herself from a marketing campaign. For example, a contact may send an email to a specific email address, requesting that the contact be removed as a message recipient for the automated marketing campaign. However, when this occurs, not only can it be time consuming for the marketer, who may have to manually remove the contact from inclusion in the target audience for the marketing campaign, but the marketer who established the marketing campaign will generally not be informed as to any specific reason that the contact requested to be excluded from the marketing campaign. For example, in many instances, even when a message recipient is prompted to provide an explanation as to why the message recipient is unsubscribing from an automated marketing campaign, the message recipient will not provide any information.

Consistent with embodiments of the present invention, when establishing an automated marketing campaign, a marketer or end-user of the messaging system is prompted to optionally specify automated exit criteria for contacts included as part of the target audience for the marketing campaign. In general, the exit criteria are specified as a conditional statement, or a combination of conditional statements logically joined by operators (e.g., AND, or OR), and referencing values for one or more fields in a contact record. For example, each contact may have a contact record in a contacts database. A custom field may be created to capture various event data relating to the contacts. Accordingly, when a contact takes some specific action, the value for the custom field associated with the contact record for that contact may be updated to reflect the specific event or interaction undertaken by the contact. When the conditional statement specified as the exit criteria is evaluated during the active period of the automated marketing campaign, the evaluation of the conditional statement may lead to the contact being removed from the target audience. For instance, when a value for a specific field referenced in a conditional statement that defines exit criteria for an automated marketing campaign is updated to reflect that the contact has taken a specific action, the conditional statement may evaluate to TRUE (or FALSE), thus causing the contact to be removed from the target audience for the automated marketing campaign.

By specifying exit criteria for an automated marketing campaign, a marketer can control when contacts included in the target audience are to be removed from the target audience of the marketing campaign, using a wide variety of very granular and specific customer data and customer event data. The conditional statements defining the exit criteria can be connected to engagement events, reserved fields, and custom fields of a contact record. Furthermore, the data fields and events upon which exit criteria conditions may depend, may be written with data in real-time, in near real-time, or on a periodic schedule (e.g., every hour), from a customer data platform that is configured to obtain and process customer data and customer event data from a wide variety of data sources. Accordingly, as customer interactions are detected, the customer data and customer event data associated with a customer interaction that is captured as a result of the customer interaction may be processed and written to a contacts database accessible to the messaging system and associated with the contact record of the customer. Consequently, interactions of the customer can ultimately trigger the satisfaction of a conditional statement associated with specified automated exit criteria, such that a contact may be removed from an automated marketing campaign. As such, a marketer may specify exit criteria for a marketing campaign, such that a contact will be removed from the target audience for the marketing campaign when the contact performs any of a wide variety of actions, such as: interacting with specific elements of a user interface (web-based, mobile applications, and so forth), concluding a transaction for the purchase of a product or service, engaging with a sales representative via a telephone call or interactive chat session, and many others.

By way of example, consider a scenario in which a marketer establishes an automated campaign aimed at persuading contacts to register for and attend a web-based product demonstration for a particular product or service. While the goal of the automated marketing campaign may be to convince or persuade contacts to register for the web-based product demonstration, the ultimate objective may be to persuade contacts to purchase a product or subscribe to a service. Accordingly, the marketer may establish first exit criteria for the marketing campaign that will remove a contact from the target audience of the automated marketing campaign, when a contact registers for the web-based product demonstration. Similarly, the marketer may establish second exit criteria for the automated marketing campaign that will remove a contact from the marketing campaign, when a contact is known to have concluded a purchase transaction for the product. In this instance, if a contact concludes a transaction to purchase the product or service, and as a result of the transaction, customer event data is received to reflect the contact's purchase of the product or service, it may be desirable to have exit criteria that would remove the contact from the automated marketing campaign. Accordingly, when the marketer is establishing the automated marketing campaign, the marketer may specify a conditional statement, as exit criteria, upon which a contact is to be removed from the automated marketing campaign. By establishing automated exit criteria in this manner, not only is the end-user experience improved, as contacts are not sent irrelevant messages, but the marketer gains a better understanding of the results of the marketing campaign. For example, using an analytics and reporting tool, the marketer can generate a report for the marketing campaign to identify the number of contacts in the target audience who exited the automated marketing campaign, and the specific reason for doing so. Other aspects and advantages of various embodiments of the present invention will be readily apparent from the description of the several figures that follows.

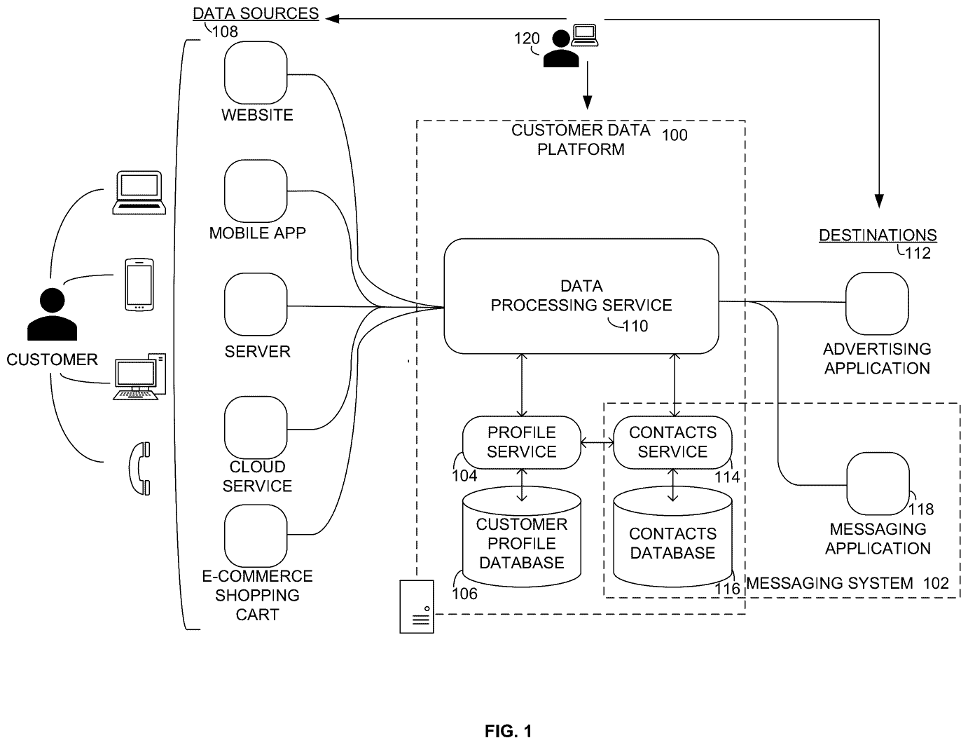

FIG. 1 is a diagram illustrating an example of a customer data platform 100 with which a messaging system 102, consistent with embodiments of the present invention, may be integrated and deployed. A customer data platform 100 is a software-based system having a customer profile service 104 for creating a persistent, unified customer profile database 106 that is accessible to a variety of applications and software-based systems (e.g., destinations 112). Customer-related event data, referred to herein as customer data and customer event data, are obtained from a variety of data sources 108 (e.g., customer touch points). The customer-related data, when received at the customer data platform 100, is processed by a data processing service 110 to “clean” the data. In this context, cleaning the data may involve validating or verifying the data, associating the customer-related data with existing customer profiles, and formatting the data. Finally, the customer-related data is forwarded to one or more data services, such as the customer profile service 104, which may combine or add the customer-related data with previously obtained customer-related data, to create for each customer a customer profile stored in a customer profile database 106.

Consistent with some embodiments, each of several different data services may subscribe to receive customer-related data from the data processing service 110. Accordingly, at least with some embodiments, in addition to a customer profile service 104, a contacts service 114 may receive customer-related data directly from the data processing service 110 and store the customer-related data in association with existing contact records in the contacts database 116. For instance, if a customer interacts with a website by concluding a purchase transaction for a product or service, the customer event data reflecting the transaction may be communicated from the website to the data processing service 110 of the customer data platform 100. In processing the customer event data, the data processing service 110 may leverage an identity resolution service (not shown) to associate the customer event data with the identity of a known customer or contact. Accordingly, when the customer event data can be associated with an existing customer or contact, the data processing service 110 may forward the customer event data to the contacts service 114, which will then store the customer event data in a data field of a contact record associated with the identity of the contact. Accordingly, each contact record in the contacts database 116 maintained by the contact service 114 may have a number of custom-defined fields, in addition to other data fields, to store specific customer event data associated with contacts who have interacted with any of a number of data sources 108. In some instances, the customer-related data that is written to a customer profile in the customer profile database 106 may also be accessed by the contacts service 114, and ultimately written to a contact record of a contact in the contacts database 116.

In general, the customer-related data arrives at the customer data platform 100 as a result of various interactions by customers with different data sources 108. Each instance of customer-related data may be associated with an event type corresponding with a specific API call or request from which the data was generated. The nature of the customer-related data may vary from one data source to the next, but will generally relate to and describe an interaction that a customer has had with one of a variety of data sources that have been configured, by an end-user 120, to operate with the customer data platform 100. Some customer-related data may be system defined, such that the customer-related data and format of the data is known in advance. In other instances, the customer-related data that results from a customer interaction may be customized for a specific application. By way of example, the customer-related data that may be included in a customer profile, and therefore accessible to the contacts service 114, may include, but is certainly not limited to:
Customer event data: web browsing activity, actions on a website or in an app, click data, and so forth.
Transactional event data: data relating to purchases, returns, data from a point-of-sale terminal, or e-commerce shopping cart.
Customer attributes: age, gender, birthday, date of first purchase, segmentation data, customer prediction data.
Campaign evaluation data: impressions, clicks, reach, engagement, emails opened or viewed, etc.
Customer-company history: data from interactions with customer service, Net Promoter Scores (NPS), data from chatbots, social media posts, survey verbatims, focus group transcripts, call center audio files, etc.

The above categories of customer-related data are provided as examples and to generally convey an understanding of the overall innovative subject matter. It will be readily appreciated that with various implementations of different customer data platforms, the nature of the customer-related data may differ from one implementation to the next, and the customer-related data may be categorized and/or referenced differently.

As shown in FIG. 1, the messaging system 102 is generally comprised of a messaging application 118, which is integrated with and configured to operate in connection with the contacts service 114 of the customer data platform 100. For example, the messaging system 102 may be a distributed system in which the contacts service 114 and the messaging application 118 reside and execute on separate computing devices. Consistent with some embodiments, the messaging system 102 may be a client-server-based system, such that marketers access the messaging application 118 via a web-browser application. Of course, with some alternative embodiments, various other system architectures may be utilized. For instance, with some embodiments, the contacts service 114 and the messaging application 118 may reside and execute on the same computing device. Although not shown in FIG. 1, consistent with some embodiments, the contacts service may include one or more data processing pipelines for uploading and maintaining contact records in a virtual data warehouse where segment queries group contact records into segments by common characteristics. Accordingly, as new and updated contact data are obtained by the contacts service, the new and updated contact data may be periodically (e.g., based on a schedule) processed by the data processing pipeline to update the segments of contacts stored in the virtual data warehouse.

Consistent with some embodiments, a marketer may interact with various user interfaces facilitated by the messaging application 118 to generate and invoke automated marketing campaigns. As part of defining an automated marketing campaign, a marketer may specify automatic exit criteria for the automated marketing campaign. For example, the marketer may specify one or more rules-based conditions or conditional statements, which reference one or more data fields in a contact record in the contacts database 116. Accordingly, the data fields that may be referenced as part of a rules-based condition may reflect values based on customer-related data that has been obtained from any of a wide variety of data sources 108. For instance, as shown in FIG. 1, the data processor 110 of the customer data platform 100 may be configured to receive customer-related data from a wide variety of data sources 108. Using various application programming interface (API) calls, when a customer interacts with a website, a mobile application, various servers, cloud-based applications, and even e-commerce shopping carts, an API call may be triggered to communicate customer-related data to the data processing service 110 of the customer data platform 100. The data processing service 110 will then process the received data by ensuring the source of data is verified, and the format of the data is appropriate. The customer-related data may then be forwarded to the contacts service 114, which will then add the data to the appropriate contact record in the contacts database 116. When the new or updated contact data is ultimately written to the virtual data warehouse, it may result in a contact record being removed from one segment of contacts (e.g., defining the target audience) and being added to a different segment of contacts (e.g., a segment of contacts that is defined based on the automated exit criteria).

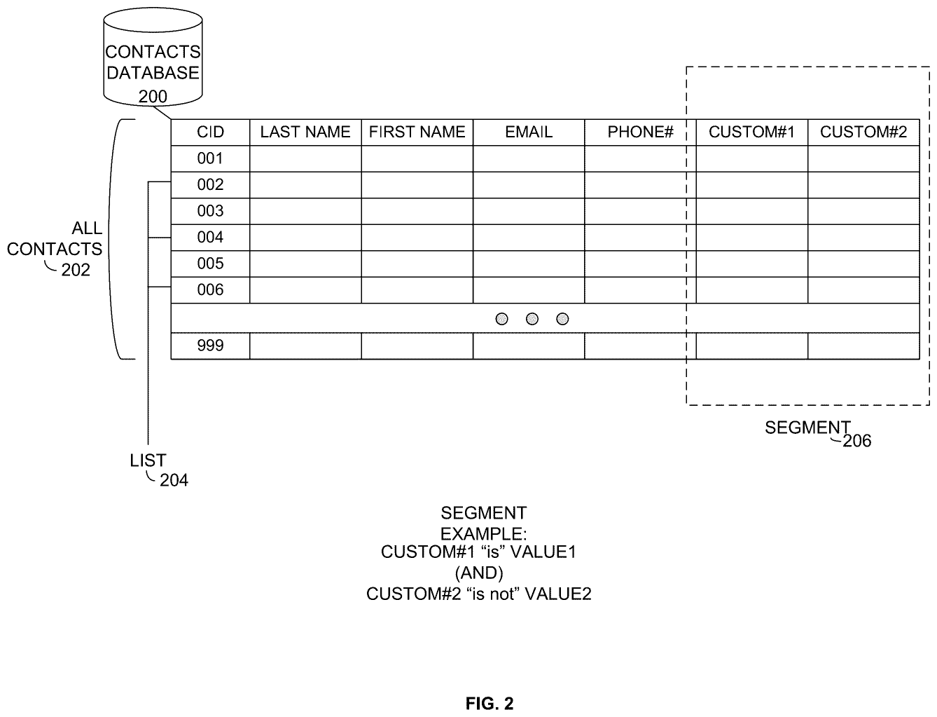

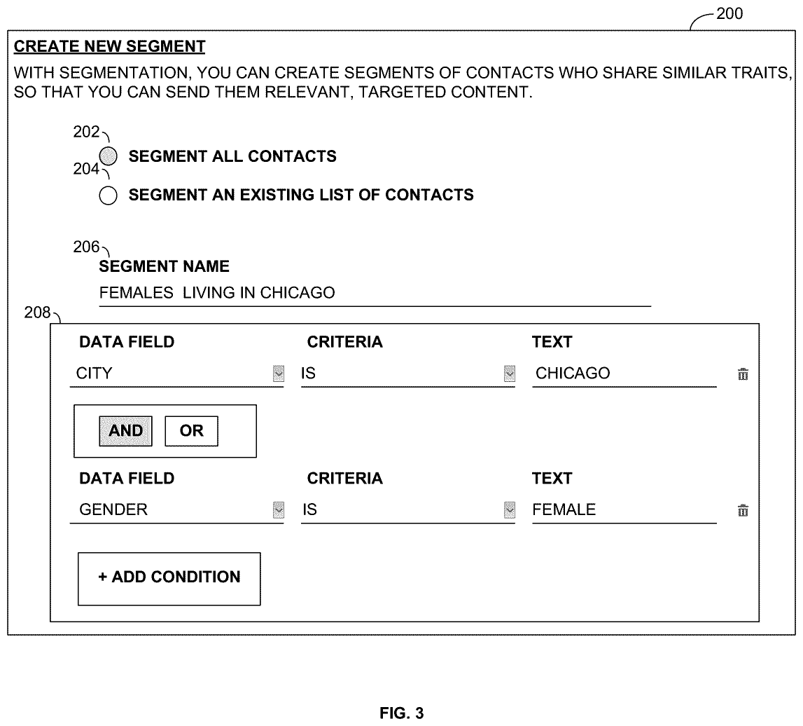

FIG. 2 is a diagram illustrating an example of a contacts database 200 from which a target audience for an automated marketing campaign may be selected or defined. As part of defining the various parameters for an automated marketing campaign, a marketer will define or create a target audience to receive messages. In various embodiments, the manner by which a target audience is created may differ. For instance, many messaging systems integrate with existing contacts databases, thereby providing the marketer with access to existing contact information for establishing a target audience. In many instances, when establishing or defining a target audience for a particular marketing campaign, a marketer may define what is referred to herein as a segment. A segment is a group of contact records that share some common characteristics, as determined by a segment query that is executed against some set of contact records. The segment query is based on a conditional statement, or a combination of conditional statements joined by a logical operator (e.g., AND or OR), and representing the desired characteristics (e.g., the entry criteria) of the target audience. By way of example, and with reference to FIG. 3, a target audience for a marketing campaign may be defined as a segment of contacts, where each contact in the segment is a female living in the city of Chicago.

As contact records are updated over time as an automated marketing campaign is in an active state, new contact records may enter the segment defined as the target audience, and existing contacts may exit the segment defined as the target audience. For instance, continuing with the example as presented in FIG. 3, if a customer having a contact record in the segment that is defined for the target audience updates his or her address to reflect a new city of residence (other than Chicago), the contact record for that customer will exit the segment of contacts that defines the target audience. Similarly, if a contact record is updated to reflect that a customer has recently relocated to the city of Chicago, when the segments are updated, the contact record for that customer may be added to the target audience, and thus the automated marketing campaign may be invoked for that customer.

By defining the target audience as a segment that may dynamically change over time, a triggering event—a concept referred to herein as entry criteria—may cause a contact to become a member of the target audience. By way of example, a triggering event may be as simple as the initial creation of a contact record in the contacts database, for example, which may occur when a person provides personal information about him or herself when first registering as an end-user of an application, online service, or website. Accordingly, an automated marketing campaign may be established by a marketer so that, after a person first registers to become an end-user of an application or online service for the very first time, a first email message is sent to the new contact welcoming the person as a new end-user. A triggering event may be based on a data field having a specific value. Accordingly, if a contact record for a specific contact is updated by writing to the specific data field a specific value, this could result in a triggering event—meaning, the contact would satisfy the entry criteria and become a member of the segment that defines the target audience.

As shown in FIGS. 2 and 3, with some embodiments, a marketer may define a target audience for an automated marketing campaign by creating a segment of contacts, by selecting contacts with certain characteristics from all contacts 202 in a contact database. Alternatively, a marketer may define a target audience by creating a segment of contacts from an existing list 204 of contacts. In this context, a list of contacts is a static subset of contacts. For instance, as shown in FIG. 2, a list of contacts 204 may be defined to include those contacts with contact identifiers (CID) shown as “002,” “004,” and “006.”

By way of example and as shown in FIG. 2, each individual contact record in the contacts database has or is otherwise associated with two separate custom data fields—“CUSTOM #1,” and “CUSTOM #2.” These are data fields that may be added by the end-user, that is, the marketer who is creating the automated marketing campaigns. A segment of contacts may be defined by specifying a condition with reference to any of the data fields in a contact record, and specifically, with reference to one or more custom data fields. For instance, in the example of FIG. 2, a dynamic subset of contacts may be defined by the segment satisfying the conditional statement, “CUSTOM #1=VALUE (AND) CUSTOM #2 !=VALUE.” As such, any contact associated with a contact record that has data in the data fields (e.g., CUSTOM #1 AND CUSTOM #2) satisfying the conditional statement established by the selected operator and value for the conditional statement, will be included in the segment. As will be described in greater detail below, a segment may be used to define not only the members of the target audience, but also those members who have exited the target audience by means of custom-defined exit criteria established for the automated marketing campaign.

As illustrated in the example user interface 300 of FIG. 3, to establish a segment, the end-user must first select whether the segment is to be based on all contacts 302, or alternatively, based on contacts in an existing list of contacts 304. Additionally, the end-user must specify a segment name 306 for the segment. Finally, the end-user must specify one or more conditional statements 308 from which the segment query will be established. Of course, if the intent is to include all contacts in the target audience, the end-user can simply skip the step of creating a conditional statement for the segment, in which case, all contacts would be included in the segment, and thus the target audience. Similarly, if the intent is to select a specific list of contacts without further conditions, the end-user can select the option 304 for generating a segment from a list, and then select all contacts in the list as the target audience by not adding any additional selection criteria (e.g., a conditional statement, such as shown with reference 308).

By way of example, an end-user may indicate that a segment is to be established based on all contacts in a contacts database. In this case, the conditional statement 308 is evaluated against all contact records for the contacts database. In the example presented in FIG. 3, if all contacts 302 has been selected, the relevant set of contacts included in the segment defining the target audience would be all contacts for which the values in their respective contact record satisfy the conditional statement 308. Here, the conditional statement indicates that the City (e.g., a data field) is Chicago (e.g., the value for the data field, City) and that the gender is female. Accordingly, the resulting set of contacts included in the segment, and thus the target audience, are all females living in the city of Chicago. Alternatively, if the end-user specifies that the segment is to be based on an existing list of contacts (e.g., the option with reference number 304), the conditional statement would be evaluated against only those contact records that are included in the specified list.

It will be appreciated that the advantage in using a segment in defining the target audience is that the target audience can be specified by any of several known characteristics of the various contacts for which data exists in the contact records. Furthermore, by using a segment as described in connection with FIGS. 2 and 3, the target audience can be defined dynamically. That is, as the various values of the data fields defining the segment change over time, contact records may be added and removed from the segment. By way of example, if someone updates their residential address as a result of moving from one city to another city, that person may be added to, or removed from, a specific segment.

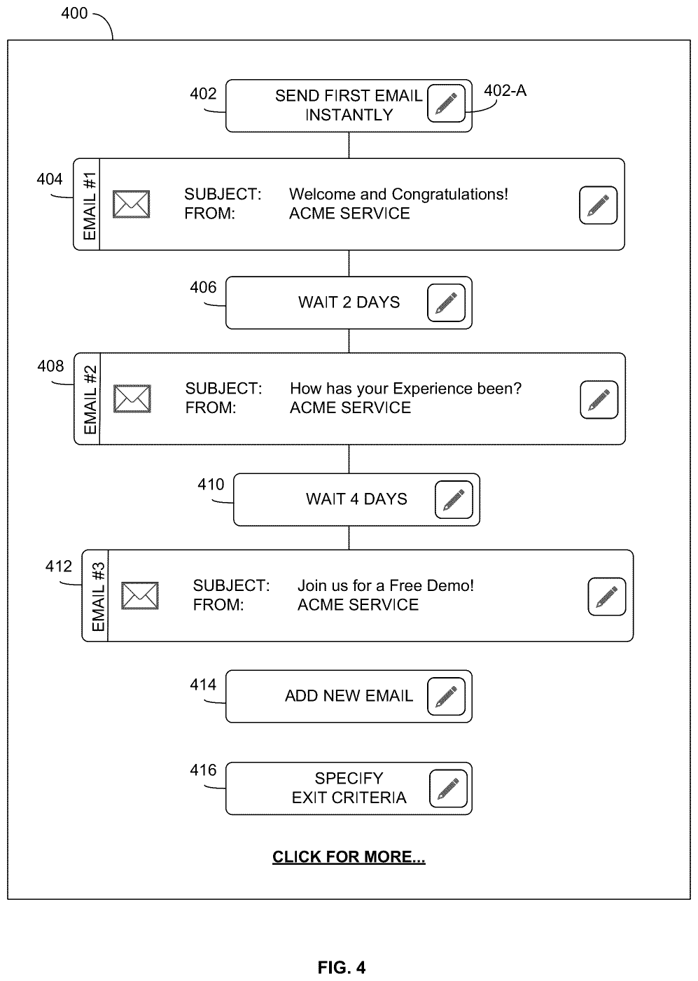

FIG. 4 is a user interface diagram illustrating an example of a user interface 400 via which an end-user (e.g., a marketer) may establish various configuration parameters for executing an automated marketing campaign, consistent with some embodiments of the present invention. As illustrated in FIG. 4, the user interface 400 shows a visual representation of the flow of an automated marketing campaign. Specifically, the visual representation of the campaign identifies three separate emails that are to be communicated to the target audience, the order in which the emails are to be communicated, and the amount of time that is to lapse between the sending of the individual emails. In this example, the topmost user interface element 402 includes a graphic or icon 402-A, which, when selected, will present various options allowing the marketer to determine how, or more precisely, when, a first message—an email in this instance—will be sent.

Each of the user interface elements labeled as emails (e.g., EMAIL #1 404, EMAIL #2 408, and EMAIL #3 412) represent a message that is part of the automated marketing campaign. By selecting the edit icon associated with each individual email, the marketer can edit the content of the email, for example, including the subject of the email, the designated email address from which the email is to be sent, and the actual content (e.g., text and images) included in the body of the email. In addition, the user interface elements with reference numbers 406 and 410 indicate the amount of time that is to lapse between the sending of individual messages. These values can be set by selecting the edit icon associated with the user interface element.

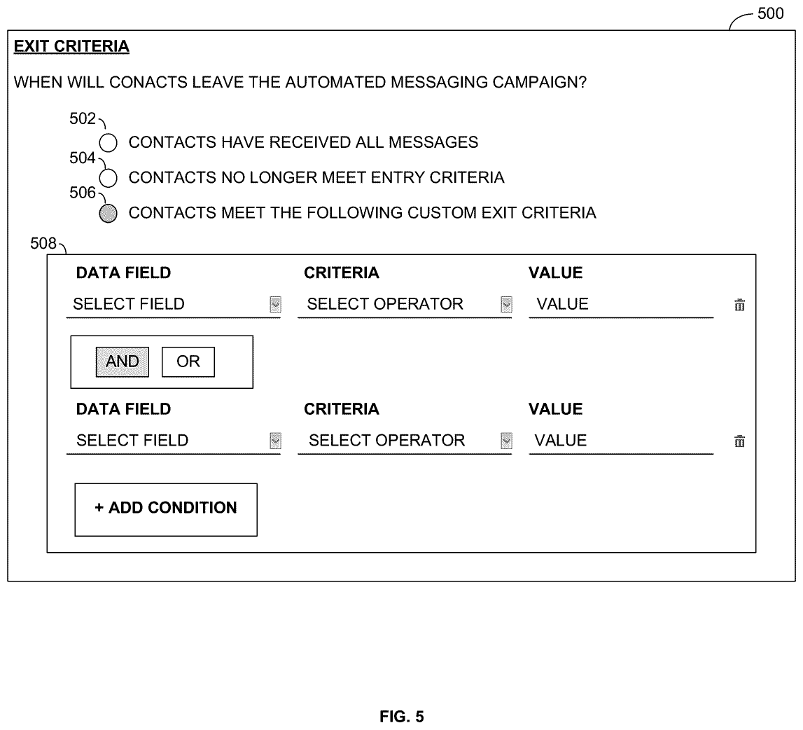

The user interface element with reference 414, when selected, causes a user interface to be presented via which the marketer can add yet another message to the automated marketing campaign. Finally, the user interface element with reference number 416, when selected, causes a user interface to be presented that allows the marketer to specify automated exit criteria for the automated marketing campaign. An example of such a user interface is presented in FIG. 5.

FIG. 5 is a diagram illustrating an example of a user interface 500 via which a marketer may specify whether an automated marketing campaign is to include automated exit criteria, and if so, a condition, which, when satisfied, will cause a contact to be removed from the marketing campaign, according to some embodiments. An end-user or marketer of a messaging system may be presented with various user interfaces for purposes of obtaining information from the end-user in order to establish a marketing campaign. As shown in FIG. 5, an end-user is being prompted to specify one of three options for establishing exit criteria for a marketing campaign. In this example, the first option 502 indicates that a contact should exit an automated marketing campaign only upon receiving all of the messages that have been specified for the automated marketing campaign. The second option 504 indicates that a contact should be removed from the automated marketing campaign when some condition associated with the entry criteria has changed, such that the contact (or, more precisely, the contact record associated with the contact) no longer satisfies the entry criteria. Finally, the third option—shown as the specified or checked option in the example of FIG. 5—indicates that a contact should be removed from an automated marketing campaign when the contact satisfies custom exit criteria. When this option is selected the user interface 500 shows various control elements that enable the marketer to establish or define a conditional statement as the exit criteria. Specifically, as shown in FIG. 5, user interface elements 508 are shown allowing the marketer to specify a data field, an operator and a value, as well as a button or element allowing for adding a second condition, joined by AND or OR. Accordingly, the marketer can establish as exit criteria a conditional statement that references any of a large number of data fields that are part of a contact record in the contacts database. This allows for significant flexibility in defining the exit criteria. Furthermore, multiple conditions can be joined together. Finally, although not explicitly illustrated in FIG. 5, the marketer may add to an automated marketing campaign more than one instance of exit criteria. Accordingly, during an active automated marketing campaign, a member of the target audience may exit the target audience for any of several different reasons, based on actions of the person satisfying any one of several different conditional statements associated with predefined exit criteria.

In the case of custom exit criteria 506, the conditional statement 508 is used to establish a segment query, which is then used to create a segment of contacts satisfying the condition(s) 508. Accordingly, as contact records are updated with new and updated contact data during an active automated marketing campaign, a contact record may be added to the segment that is associated with the custom exit criteria. When this occurs, the contact is considered to have exited the target audience, and will no longer be sent any messages as part of the automated marketing campaign.

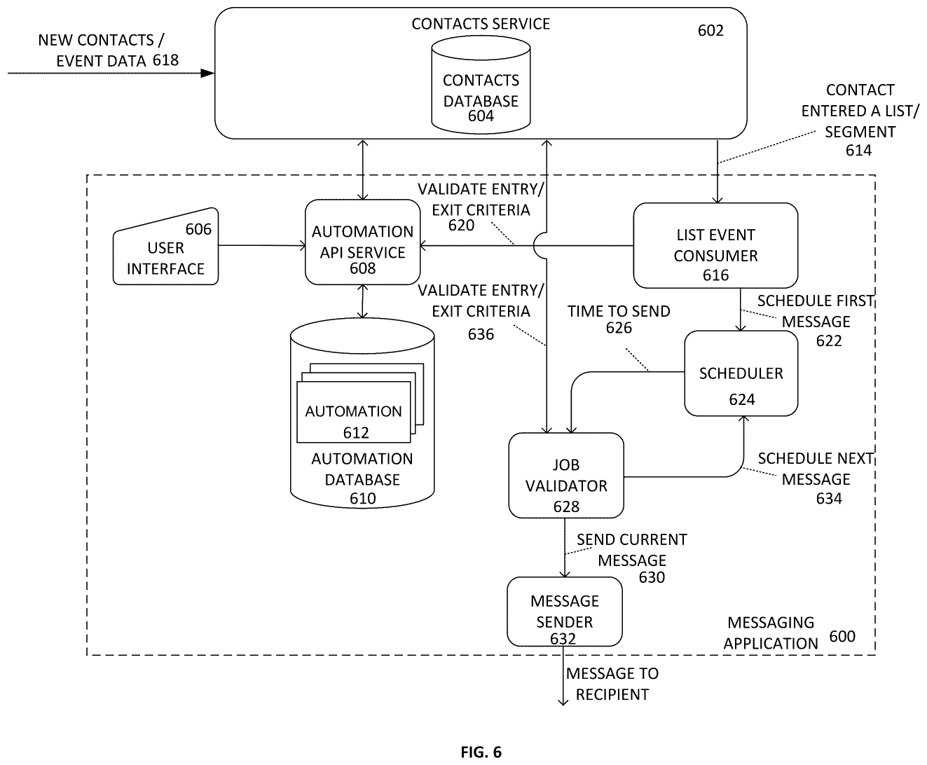

FIG. 6 is a diagram illustrating an example of various functional components included in a messaging system that facilitates automated marketing campaigns, or automations, that support automated exit criteria, consistent with embodiments of the invention. As illustrated in FIG. 6, the messaging system is generally comprised of two primary components—the messaging application 600 and the contacts service 602, which maintains the contacts database 604 and the various segments that define the target audience, as well as those segments of contacts that may have exited the target audience. The messaging application 600 has a user interface component 606 that facilitates the presentation of various user interfaces to an end-user. Via the user interfaces, an end-user generates the content for each message and specifies the various configuration parameters that determine the behavior of an automation. Specifically, in addition to facilitating the creation of the actual messages, the one or more user interfaces presented to an end-user allow the end-user to establish configuration parameters for an automation, which may include, for example, the entry criteria, the exit criteria, the order of messages, the time between sending messages (e.g., the schedule), among other parameters.

Consistent with some embodiments, the user interface component 606 may be facilitated with a web server, such that the end-user accesses the various user interfaces using a web browser application. In any case, via the user interfaces facilitated via the user interface component 606, the end-user is able to establish and define an individual automated marketing campaign, or automation 612, which is stored in the automation database 610. With some embodiments, the configuration of each automation is accomplished via an automation API service 608. For example, when an end-user defines a target audience by generating a segment (e.g., as illustrated in FIG. 3), an API call may write the segment definition (e.g., a segment query) to a segments database (not shown) managed by the contacts service 602. Similarly, when an end-user establishes custom exit criteria (e.g., as illustrated in FIG. 5), a segment query is generated based on the specified conditional statement defining the exit criteria, and written to the segment database managed by the contacts service 602. Once the segment query for the target audience has been established, the segment query will be processed to generate the segment of contact records representing the target audience. Similarly, one or more additional segment queries—each associated with a specific instance of custom exit criteria—may be executed to create segments of contacts satisfying respective exit criteria. Accordingly, as the contact service 602 receives new contact data in the way of new contacts and new customer-related event data associated with existing contacts, the contact records of the contacts will be updated, and in some instances, this will cause contacts to be added to, or removed from, different segments—including those that define the target audience and those that define the contacts who have exited the target audience.

Once the automated marketing campaign or automation has been defined and stored in the automation database 620, an end-user will activate the automation. Accordingly, a data field associated with the automation, as stored in the automation database 610, may be updated to indicate that the automation has been activated.

As indicated by the line with reference number 618, as new contact information is received at the contacts service 602, the contact data 618 is written to the contacts database 604 and a scheduled task is executed to periodically execute the various segment queries, thereby updating the various segments that define the target audience and any segments that are based on custom exit criteria. Accordingly, as the segment queries are periodically executed, various contact records may be added to or removed from different segments. During the active stage of an automation, the contacts service 602 will publish data relating to the membership of contacts in various lists or segments via a publish-subscribe message distribution service—as indicated by the line with reference number 614. For example, the contacts service 602 will publish a stream of delta events relating to the contacts that have been added to various segments or lists. The list event consumer 616, which subscribes to messages posted by the contacts service 602, receives and processes the stream of delta events published by the contacts service 602, including the data identifying the contacts that are new members of various lists or segments. The list event consumer 616 will check the received data against any active automations, as indicated by the line with reference number 620. Specifically, based on the data 614 received from the contacts service 602, the list event consumer 616 will determine if any contacts satisfy entry or exit criteria for an active automation. In general, this is accomplished by comparing the segment or list identifiers that indicate the segment or list that a contact is assigned to, as indicated in the data 614 received from the contacts service 602, against the segment identifiers associated with the target audience and/or exit criteria as defined by an automation 612 in the automation database 610.

By way of example, if data 614 received at the list event consumer 616 indicates that a contact record has been added to a segment associated with the entry criteria for an automation (as determined by the validation step 620), the list event consumer 616 will then communicate information—as indicated by the line with reference number 622—to the scheduler 624, directing the scheduler 624 to schedule a task for the sending of a message, as specified in the relevant automation 612. As the automation 612 may have a defined schedule for the sending of messages, when the time comes to actually execute the scheduled task and send the message, per the schedule, the scheduler 624 will communicate instructions to the job validator 628—as indicated by the line with reference 626—instructing the job validator 628 to proceed with validating the task of sending the message, just before executing the task to send the message. Accordingly, when the job validator 628 receives instructions 626 from the scheduler 624, the job validator 628 will validate the entry criteria and/or exit criteria—as indicated by the line with reference number 636—just prior to instructing the message sender 632 to send a message.

Here, validating the entry and exit criteria may depend upon how the automation was configured. For example, if no specific exit criteria has been established for the automated marketing campaign (consistent with the option having reference number 502 in FIG. 5), then the job validator 628 need not perform any validation task. However, if the automation has been configured such that each contact should receive the next message in a series of messages so long as the contact continues to satisfy the entry criteria (consistent with the option having reference number 504 in FIG. 5), then the job validator 628 will validate that the contact is in the segment defining the target audience, prior to executing the task of sending the next message. Finally, if the automation has been defined with custom exit criteria (consistent with the option having reference number 504 in FIG. 5), the job validator 628 will confirm that the contact record for the contact is not in the segment of contacts associated with the specified exit criteria, prior to executing the task to send the next message.

Between the sending of each message as set forth by a specific automation, the job validator 628 will re-evaluate the contact record associated with a contact to whom a message has been scheduled for sending. If the exit criteria for the automation has been set to “no longer meets entry criteria,” each contact's membership in the segment for the entry criteria is reevaluated. If a contact record is no longer in a list or segment for the entry criteria, or the contact has been deleted outright, then the contact will stop receiving any subsequent messages specified for the automation. That contact is considered to have exited the automation. If the exit criteria is set to use custom exit criteria, the job validator 628 will validate the contact record by checking to see if the contact record is in a segment associated with the one or more conditional statements specified as the custom exit criteria. If the contact record is in a segment associated with any one of several exit criteria defined for the automated marketing campaign, the contact is considered to have exited the automation, and the next message of the automation is not sent to the contact.

The job validation task is performed to ensure that a change to a contact record that may have occurred after a message has been scheduled to be sent, but before the actual scheduled time to send the message, has resulted in the contact exiting the target audience. For instance, because there may be a delay in sending a scheduled message to a contact, the job validator 628 ensures that a potential message recipient has not exited the target audience just before the job validator 628 sends instructions 620 to the message sender 632 to send the message. Here, exiting the target audience may occur when the contact record no longer satisfies the entry criteria defining the target audience, or the contact record may satisfy exit criteria.

After validating the entry criteria or exit criteria 636, when the job validator 628 sends instructions 630 to the message sender 632 instructing the message sender 632 to send the message to the message recipient, the job validator 628 will also send an instruction 634 to the scheduler 624 to schedule the sending of the next message, if any, in the automation.

By implementing custom, automated exit criteria in this manner, the end-user experience is improved. For instance, when an end-user has taken some action that is consistent with the objective of a marketing campaign, the end-user may be removed from the automated marketing campaign and will therefore not receive irrelevant messages. Furthermore, with some embodiments, an analytics and reporting tool can provide insights into the members of the target audience who were removed from the target audience, and the reason why the members were removed. For example, a report may be generated to reflect various characteristics of the contacts who were exited from a target audience for having satisfied specific exit criteria. This can be useful information in allowing the marketer to fine tune the content of a message used in a subsequent automation, and/or to fine tune the definition of the target audience for an automation.

### Machine Architecture

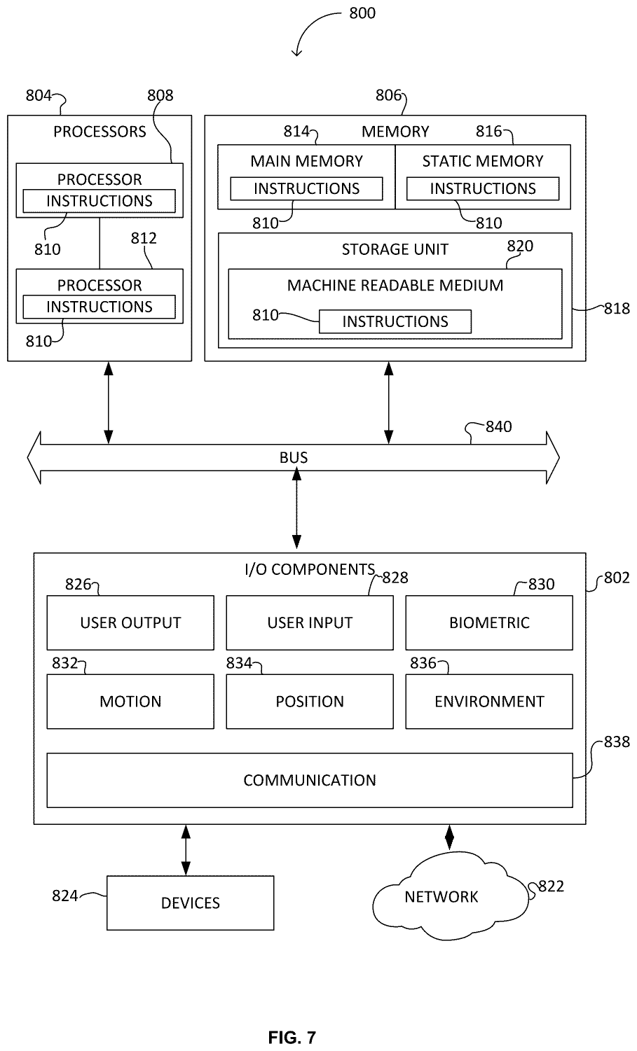

FIG. 7 is a diagrammatic representation of a machine 800—sometimes referred to as a computing device—within which instructions 810 (e.g., software, a program, an application or app, or other executable code) for causing the machine 800 to perform any one or more of the methodologies discussed herein may be executed. For example, the instructions 810 may cause the machine 800 to execute any one or more of the methods described herein. The instructions 810 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine (e.g., client computing device) in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 810, sequentially or otherwise, that specify actions to be taken by the machine 800. Further, while a single machine 800 is illustrated, the term “machine” shall also be taken to include a collection of machines that individually or jointly execute the instructions 810 to perform any one or more of the methodologies discussed herein. The machine 800, for example, may comprise the client machine(s) 310 or any one of multiple server devices forming part of the customer data platform 300. In some examples, the machine 800 may also comprise both client and server systems, with certain operations of a particular method or algorithm being performed on the server-side and with certain operations of the particular method or algorithm being performed on the client-side.

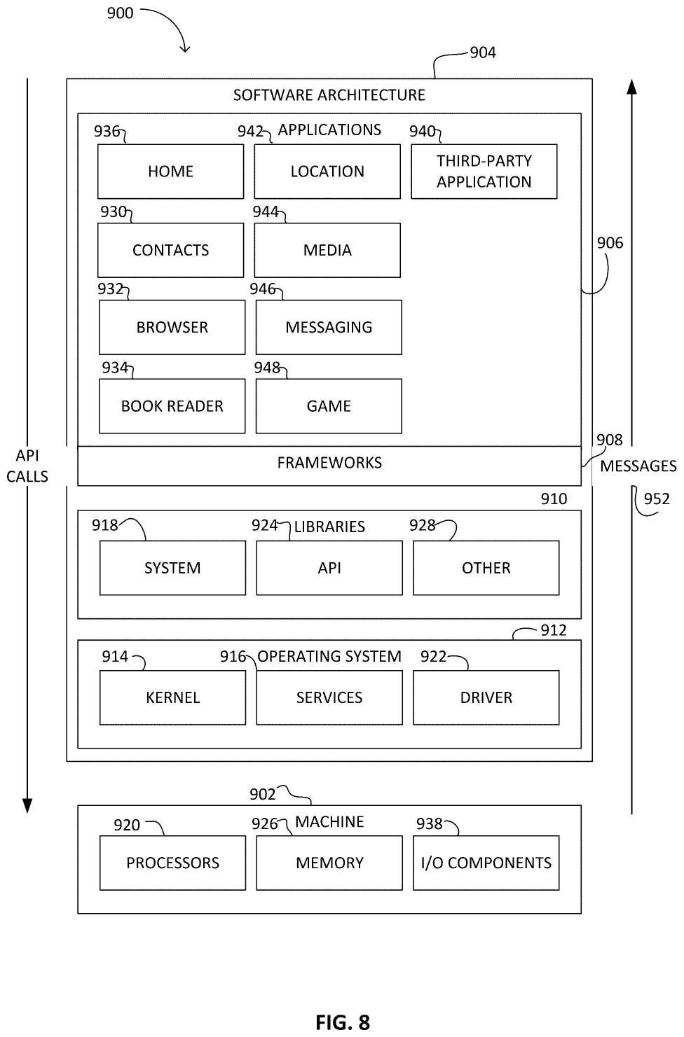

The machine 800 may include processors 804, memory 806, and input/output I/O components 802, which may be configured to communicate with each other via a bus 840. In an example, the processors 804 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 808 and a processor 812 that execute the instructions 810. The term “processor” is intended to include multi-core processors that may comprise two or more independent processors (sometimes referred to as “cores”) that may execute instructions contemporaneously. Although FIG. 8 shows multiple processors 804, the machine 800 may include a single processor with a single-core, a single processor with multiple cores (e.g., a multi-core processor), multiple processors with a single core, multiple processors with multiples cores, or any combination thereof.

The memory 806 includes a main memory 814, a static memory 816, and a storage unit 818, all accessible to the processors 804 via the bus 840. The main memory 806, the static memory 816, and storage unit 818 store the instructions 810 embodying any one or more of the methodologies or functions described herein. The instructions 810 may also reside, completely or partially, within the main memory 814, within the static memory 816, within machine-readable medium 820 within the storage unit 818, within at least one of the processors 804 (e.g., within the processor's cache memory), or any suitable combination thereof, during execution thereof by the machine 800.

The I/O components 802 may include a wide variety of components to receive input, provide output, produce output, transmit information, exchange information, capture measurements, and so on. The specific I/O components 802 that are included in a particular machine will depend on the type of machine. For example, portable machines such as mobile phones may include a touch input device or other such input mechanisms, while a headless server machine will likely not include such a touch input device. It will be appreciated that the I/O components 802 may include many other components that are not shown in FIG. 8. In various examples, the I/O components 802 may include user output components 826 and user input components 828. The user output components 826 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 802 may include biometric components 830, motion components 832, environmental components 836, or position components 834, among a wide array of other components. For example, the biometric components 830 include components to detect expressions (e.g., hand expressions, facial expressions, vocal expressions, body gestures, or eye-tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 832 include acceleration sensor components (e.g., accelerometer), gravitation sensor components, rotation sensor components (e.g., gyroscope).

The environmental components 836 include, for example, one or more image sensors or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 834 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 802 further include communication components 838 operable to couple the machine 800 to a network 822 or devices 824 via respective coupling or connections. For example, the communication components 838 may include a network interface component or another suitable device to interface with the network 822. In further examples, the communication components 838 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 824 may be another machine or any of a wide variety of peripheral devices (e.g., a peripheral device coupled via a USB).

Moreover, the communication components 838 may detect identifiers or include components operable to detect identifiers. For example, the communication components 838 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 838, such as location via Internet Protocol (IP) geolocation, location via Wi-Fi® signal triangulation, location via detecting an NFC beacon signal that may indicate a particular location, and so forth.

The various memories (e.g., main memory 814, static memory 816, and memory of the processors 804) and storage unit 818 may store one or more sets of instructions and data structures (e.g., software) embodying or used by any one or more of the methodologies or functions described herein. These instructions (e.g., the instructions 810), when executed by processors 804, cause various operations to implement the disclosed examples.

The instructions 810 may be transmitted or received over the network 822, using a transmission medium, via a network interface device (e.g., a network interface component included in the communication components 838) and using any one of several well-known transfer protocols (e.g., hypertext transfer protocol (HTTP)). Similarly, the instructions 810 may be transmitted or received using a transmission medium via a coupling (e.g., a peer-to-peer coupling) to the devices 824.

### Software Architecture

FIG. 8 is a block diagram 900 illustrating a software architecture 904, which can be installed on any one or more of the computing devices described herein. The software architecture 904 is supported by hardware such as a machine 902 that includes processors 920, memory 926, and I/O components 938. In this example, the software architecture 904 can be conceptualized as a stack of layers, where each layer provides a particular functionality. The software architecture 904 includes layers such as an operating system 912, libraries 910, frameworks 908, and applications 906. Operationally, the applications 906 invoke API calls 950 through the software stack and receive messages 952 in response to the API calls 950.

The operating system 912 manages hardware resources and provides common services. The operating system 912 includes, for example, a kernel 914, services 916, and drivers 922. The kernel 914 acts as an abstraction layer between the hardware and the other software layers. For example, the kernel 914 provides memory management, processor management (e.g., scheduling), component management, networking, and security settings, among other functionalities. The services 916 can provide other common services for the other software layers. The drivers 922 are responsible for controlling or interfacing with the underlying hardware. For instance, the drivers 922 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 910 provide a common low-level infrastructure used by the applications 906. The libraries 910 can include system libraries 918 (e.g., C standard library) that provide functions such as memory allocation functions, string manipulation functions, mathematic functions, and the like. In addition, the libraries 910 can include API libraries 924 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 910 can also include a wide variety of other libraries 928 to provide many other APIs to the applications 906.

The frameworks 908 provide a common high-level infrastructure that is used by the applications 906. For example, the frameworks 908 provide various graphical user interface (GUI) functions, high-level resource management, and high-level location services. The frameworks 908 can provide a broad spectrum of other APIs that can be used by the applications 906, some of which may be specific to a particular operating system or platform.

In an example, the applications 906 may include a home application 936, a contacts application 930, a browser application 932, a book reader application 934, a location application 942, a media application 944, a messaging application 946, a game application 948, and a broad assortment of other applications such as a third-party application 940. The applications 906 are programs that execute functions defined in the programs. Various programming languages can be employed to create one or more of the applications 906, structured in a variety of manners, such as object-oriented programming languages (e.g., Objective-C, Java, or C++) or procedural programming languages (e.g., C or assembly language). In a specific example, the third-party application 940 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 940 can invoke the API calls 950 provided by the operating system 912 to facilitate functionalities described herein.

1. A computer-implemented method for conducting an automated marketing campaign, the method comprising:
receiving information for generating a plurality of individual messages for sending, serially, to each contact included in a target audience;
receiving configuration parameters for the automated marketing campaign, the configuration parameters comprising i) entry criteria for determining a contact record for a contact is included in the target audience, and ii) exit criteria for determining a contact record for a contact has exited the automated marketing campaign;
subsequent to i) receiving information for generating the plurality of individual messages and ii) receiving the configuration parameters for the automated marketing campaign, activating the automated marketing campaign in response to end-user input;
during the active automated marketing campaign, to in response to determining that a first contact, associated with a first contact record, is included in the target audience, scheduling a first task to be executed at a first time, wherein the first task is to send a first message of the plurality of individual messages to the first contact; and
at the first time, executing the first task to send the first message to the first contact after confirming that the first contact record, associated with the first contact, does not satisfy the exit criteria.

2. The computer-implemented method of claim 1, further comprising:
subsequent to sending the first message to the first contact, scheduling a second task to be executed at a second time, wherein the second task is to send a second message of the plurality of individual messages to the first contact; and
at the second time, not executing the second task to send the second message to the first contact after confirming that the first contact record, associated with the first contact, does satisfy the exit criteria.

3. The computer-implemented method of claim 2, wherein the exit criteria for determining a contact record for a contact has exited the automated marketing campaign indicates that a contact has exited the automated marketing campaign when the contact record of the contact no longer satisfies the entry criteria.

4. The computer-implemented method of claim 3, wherein the entry criteria for determining a contact record for a contact is included in the target audience indicates that a contact is included in the target audience when the contact record of the contact satisfies a conditional statement that is used to generate a segment query, which, when executed, updates a segment table to include contact records having data fields that satisfy the segment query;
wherein confirming that the first contact record, associated with the first contact, does satisfy the exit criteria, comprises determining that first contact record is in the segment table.

5. The computer-implemented method of claim 2, wherein the exit criteria for determining a contact record for a contact has exited the automated marketing campaign indicates that a contact has exited the automated marketing campaign when the contact record of the contact satisfies a conditional statement that is used to generate a segment query, which, when executed, updates a segment table to include contact records having data fields that satisfy the segment query.

6. The computer-implemented method of claim 5, wherein confirming that the first contact record, associated with the first contact, does satisfy the exit criteria, comprises determining that first contact record is in the segment table.

7. The computer-implemented method of claim 2, wherein the exit criteria for determining a contact record for a contact has exited the automated marketing campaign indicates that a contact has exited the automated marketing campaign when the contact record of the contact satisfies a combination of individual conditional statements, each individual conditional statement having an operator and referencing at least one value in a data field of a contact record, the individual conditional statements joined by AND or OR, the combination of conditional statements used to generate a segment query, which, when executed, updates a segment table to include contact records having data fields that satisfy the segment query.

8. The computer-implemented method of claim 1, wherein the first contact record includes one or more data fields for storing customer-related event data forwarded to a contacts service after being obtained by a customer data platform as a result of a contact interacting with one of a plurality of data sources configured to communicate event data to the customer data platform.

9. A system for conducting an automated marketing campaign, the system comprising:
a processor for executing computer-readable instructions;
a memory storage device storing instructions thereon, which, when executed by the processor, cause the system to perform operations comprising:
receiving information for generating a plurality of individual messages for sending, serially, to each contact included in a target audience;
receiving configuration parameters for the automated marketing campaign, the configuration parameters comprising i) entry criteria for determining a contact record for a contact is included in the target audience, and ii) exit criteria for determining a contact record for a contact has exited the automated marketing campaign;
subsequent to i) receiving information for generating the plurality of individual messages and ii) receiving the configuration parameters for the automated marketing campaign, activating the automated marketing campaign in response to end-user input;
during the active automated marketing campaign, to determining that a first contact, associated with a first contact record, is included in the target audience, scheduling a first task to be executed at a first time, wherein the first task is to send a first message of the plurality of individual messages to the first contact; and
at the first time, executing the first task to send the first message to the first contact after confirming that the first contact record, associated with the first contact, does not satisfy the exit criteria.

10. The system of claim 9, wherein the instructions, when executed by the processor, cause the system to perform additional operations comprising:
subsequent to sending the first message to the first contact, scheduling a second task to be executed at a second time, wherein the second task is to send a second message of the plurality of individual messages to the first contact; and
at the second time, not executing the second task to send the second message to the first contact after confirming that the first contact record, associated with the first contact, does satisfy the exit criteria.

11. The system of claim 10, wherein the exit criteria for determining a contact record for a contact has exited the automated marketing campaign indicates that a contact has exited the automated marketing campaign when the contact record of the contact no longer satisfies the entry criteria.

12. The system of claim 11, wherein the entry criteria for determining a contact record for a contact is included in the target audience indicates that a contact is included in the target audience when the contact record of the contact satisfies a conditional statement that is used to generate a segment query, which, when executed, updates a segment table to include contact records having data fields that satisfy the segment query;
wherein confirming that the first contact record, associated with the first contact, does satisfy the exit criteria, comprises determining that first contact record is in the segment table.

13. The system of claim 10, wherein the exit criteria for determining a contact record for a contact has exited the automated marketing campaign indicates that a contact has exited the automated marketing campaign when the contact record of the contact satisfies a conditional statement that is used to generate a segment query, which, when executed, updates a segment table to include contact records having data fields that satisfy the segment query.

14. The system of claim 13, wherein confirming that the first contact record, associated with the first contact, does satisfy the exit criteria, comprises determining that first contact record is in the segment table.

15. The system of claim 10, wherein the exit criteria for determining a contact record for a contact has exited the automated marketing campaign indicates that a contact has exited the automated marketing campaign when the contact record of the contact satisfies a combination of individual conditional statements, each individual conditional statement having an operator and referencing at least one value in a data field of a contact record, the individual conditional statements joined by AND or OR, the combination of conditional statements used to generate a segment query, which, when executed, updates a segment table to include contact records having data fields that satisfy the segment query.

16. The system of claim 9, wherein the first contact record includes one or more data fields for storing customer-related event data forwarded to a contacts service after being obtained by a customer data platform as a result of a contact interacting with one of a plurality of data sources configured to communicate event data to the customer data platform.

17. A system for conducting an automated marketing campaign comprising:
means for receiving information for generating a plurality of individual messages for sending, serially, to each contact included in a target audience;
means for receiving configuration parameters for the automated marketing campaign, the configuration parameters comprising i) entry criteria for determining a contact record for a contact is included in the target audience, and ii) exit criteria for determining a contact record for a contact has exited the automated marketing campaign;
subsequent to i) receiving information for generating the plurality of individual messages and ii) receiving the configuration parameters for the automated marketing campaign, activating the automated marketing campaign in response to end-user input;
during the active automated marketing campaign, to determining that a first contact, associated with a first contact record, is included in the target audience, means for scheduling a first task to be executed at a first time, wherein the first task is to send a first message of the plurality of individual messages to the first contact; and
at the first time, means for executing the first task to send the first message to the first contact after confirming that the first contact record, associated with the first contact, does not satisfy the exit criteria.

18. The system of claim 17, further comprising:
subsequent to sending the first message to the first contact, means for scheduling a second task to be executed at a second time, wherein the second task is to send a second message of the plurality of individual messages to the first contact; and
at the second time, means for not executing the second task to send the second message to the first contact after confirming that the first contact record, associated with the first contact, does satisfy the exit criteria.

19. The system of claim 18, wherein the exit criteria for determining a contact record for a contact has exited the automated marketing campaign indicates that a contact has exited the automated marketing campaign when the contact record of the contact no longer satisfies the entry criteria.

20. The system of claim 19, wherein the entry criteria for determining a contact record for a contact is included in the target audience indicates that a contact is included in the target audience when the contact record of the contact satisfies a conditional statement that is used to generate a segment query, which, when executed, updates a segment table to include contact records having data fields that satisfy the segment query;
wherein confirming that the first contact record, associated with the first contact, does satisfy the exit criteria, comprises determining that first contact record is in the segment table.
